(19) United States
(12) Patent Application Publication
(10) Pub. No.: US 2008/0121191 A1
(43) Pub. Date: May 29, 2008

(54) BABY WALKER/WALKING SAFETY BELT APPARATUS

(76) Inventor: Tianyun Wu, San Francisco, CA (US)

Correspondence Address: TIANYUN WU, 1390 MARKET ST., # 2614, SAN FRANCISCO, CA, 94102, US

(21) Appl. No.: 11/467,324

(22) Filed: Aug. 25, 2006

(51) Int. Cl. A62B 35/00; B60R 22/00; B60R 22/12

(52) U.S. Cl. 119/770; 224/158

(57) ABSTRACT

Disclosed is a portable device to help adults hold and support their infants without bending their backs. This safety device is a semi-circular belt-shaped fabric product that is preferably well-padded with soft durable materials. It is primarily used for training and assisting infants to walk during the early development stages and beyond. It also functions to minimize back strain on the child caregiver by eliminating back bending when holding a child who is a significantly different height. The revolutionary technical design allows this device to be simple to make and simple to use, with the advantages of long-term usage and multiple functions, such as securing an infant onto a chair. All of these features are lacking in similar products in the prior art.

### FIELD OF INVENTION

The present invention relates primarily to a child walking safety product.

### BACKGROUND OF THE INVENTION

Today, older first-time parents are very common. Many women have their first child after 40 years of age. About 25% of all women in California have their first birth at an age over 35. This trend is seen all over the world. Many men at the age of 50-65 are having new babies. Many elderly people, such as grandparents, are childcare givers to their grandchildren. As soon as a small baby becomes mobile, such as crawling, standing, cruising and walking, the parents or attendants can expect a lot of work. Very often a small baby will trip and fall while learning to stand or walk. At those times, an older parent will have a very difficult time bending over, as many have by then experienced back injuries, back pain, or knee pain before having a child. Back pain and tiredness are common complaints by parents during the period when their children learn to walk.

Normal infants learn to walk as early as 6-7 months and as late as 14-16 months. During this period of time, a caregiver spends between 30 min per day to 3-4 hours per day assisting the baby with walking. Due to the significant height difference between a small child and his or her attendant, it is natural for the attendant to bend forward the upper-body to reach a small child with both arms and hands. Thus, this small child's arms or under arms are held by the attendant's hands. In other words, to be able to reach a small child, the attendant bends her/his back to hold the small child's arms when the child stands or walks. This is an extremely difficult position for many people, especially for an older person, a tall person or a person who has back problems. More importantly, when the child's arms are held by the attendant, the infant's arms and hands cannot move freely and naturally, so that the child is not able to touch, grasp, or play with objects as he or she desires. Also, the attendant's both hands are not free in this back bending position. Accidentally, many small children's arms or shoulders have been injured or twisted from sudden lifting or pulling because their attendants could not coordinate with the baby's movement.

Therefore, keeping a baby's hands free during walking exercise is very important in many ways: 1) it allows the baby to have good coordination between the body and hands, so that the baby can be in a natural physical position as much as possible during practicing walk; 2) most important, it helps to stimulate small babies brain development because it provides a great opportunity for a baby to receive information through hands. As we know, the learning process at this age relies mostly on hand touching. During the first three years of an infant's development, the brain develops most significantly in mass and in establishing synapses. It would be a great opportunity to receive a large amount of stimulations if a baby can go any place where a grown-up goes, such as walking into elevators, climbing up stairs, and walking on grass, pavement, shores of lakes or rivers, or anywhere. The more information a baby obtains, the more synapses can be developed, and the more intelligent a baby can become, and the earlier a baby can become independent. Learning how to step as well as obtaining information through this process will stimulate the child's brain development, which benefits both motor functions as well as intellectual development. Generally, due to safety concerns, most parents will not bring their babies to many places until their children reach a certain age. This present invention will provide a useful device to help save a lot of physical effort, avoid emotional stress and ease the burden of parenting. It helps stimulate small babies during the early development stage and explore the world safely.

The earliest infant-walking aid invention was made as early as 1916. However, effective baby walking aids for training a small baby to walk are still lacking in the market. For example, U.S. Pat. No. 1,193,374 granted in 1916, discloses a walking harness. This harness uses two parallel straps to surrounding the wearer's upper body. The hand-holding straps are narrowed straps that form a loop structure by connecting the ends. The harness is attached to the center back of the wearer. This design is very similar to most baby walking safety harnesses on the market today. The harness is normally operated by a single hand. The harness may be useful for keeping a toddler or older child nearby, but it is not a proper device to train a small baby to walk. When a baby is lifted at the center of the back, the baby can easily become out of balance and falls.

U.S. Pat. No. 1,749,999 helps an adult assist a small baby to learn how to walk. It was developed as a garment-like apparatus that is worn by a baby. Two straps extend from the back of the shoulder to be held by a caregiver's hands. There are many disadvantages in this prior art device: the hand straps are very narrow straps that provide no protection to the wearer. When the straps are pulled, the front anterior part of the apparatus could be pulled up toward the wearer's neck, and may become a choking hazard. No buckles were available at that time, and it seems difficult to put on or take off this apparatus. The wearer can become very hot when used during the summer.

U.S. Pat. No. 5,120,287 discloses a system in which two solid wood bars are provided for the caregiver and the baby to hold onto. The baby has to use its hands to hold onto the wooden bars, and therefore does not get its hands free. This prior art reference discloses a strap system used to hold on the baby's bottom, which does not seem to be convenient for a small baby when a baby starts to walk. It is always important for a baby that there is no obstacle below the waist and no other obstacle stretching between the legs. In addition, the solid rigid bar system is not as convenient as foldable clothes for storage and transportation.

The most recent U.S. Pat. No. 6,836,902, discloses a design similar to the design described in the U.S. Pat. No. 1,749,999, but adding a seat part for holding the wearer's bottom. The tensions at the baby's bottom and legs create an unnatural force by the infant when the harness is in use. Plus, this suit-liked garment limits the time that it can be used. It may work for smaller or younger babies, and definitely not good for a larger or older babies. The hand leashes are thin, offer no protection and provide less control to the wearers. A baby wearing such a harness is like a baby in a suit or in a net. It may be too hot for a baby to use during summer and is not easy to put on or remove.

Baby walkers help a baby learn to walk. A baby walker has a seat and wheels that allow a baby to sit inside surrounded by a frame. The wheels allow a baby to walk around. For example, U.S. Pat. No. 3,778,052 shows a wheeled support structure. After baby walkers become popular several years ago, many babies fell from the stairs in these walkers and became seriously injured. Now, these wheeled walkers are considered dangerous for infants and have been taken off the market. In addition, even before they are able to walk independently, many small babies have strong desire to walk and play in the playground like the big kids do. They also desire to experience with their attendants in going into elevators, on stairs, through doors, and on pavement or grass. However, all of these wheeled devices for assisting a baby walk cannot fulfill these needs.

Currently, here are many types of baby safety walking harnesses in the market, which are intended for toddlers who are able to walk already. They are used as restraining devices for keeping the kids nearby and to avoid being lost in the crowd or on the street. Most of the walking harnesses are made from webbing saps and have a long leash attached on the center back; some are designed to attach to the both sides of under-arms. They are not designed or cannot be used to assist an infant to learn how to walk.

### SUMMARY OF THE INVENTION

This present invention provides a baby safety walking apparatus which is carried by a baby and held by an attendant. It is designed to secure and support activities of infants during their early stages of development, such as crawling, standing, or walking. It prevents trip and falls and gives confidence to the infants. It is mostly designed to help the attendant to release back strain and reduce the physical and emotional stresses when giving care to a small child. This baby walking safety belt apparatus comprises a major body part and four additional strap systems:
1) A semicircular fan-shaped front bib: it functions as human hands, supports and protects the wearer's upper torso. It is the wide and well-padded center portion of the apparatus that surrounds the wearer's chest area and terminates behind the arm-pits.
2) Two wing-shaped arm-extensions: they function as human arms to allow the attendant's arms extending long enough to be able to hold a small child without back bending. Child caregivers thus can stand and walk in a nearly normal position. The body part of the functional apparatus is the structure formed by attaching these two arm-extensions to the center portion. When lifted, the supporting force to the wearer is translated from the front chest to the left and right side of the arm pits. The arm extensions are designed as a shape of a dragonfly's wings, which are wide and well-padded. They can provide a strong lift and good support.
3) An adjustable shoulder-strap system, wherein two straps are used to attach the apparatus to the wearer's body. Each shoulder strap passes through a D-ring which is attached on the inner side of an arm-extension by an adjustable buckle.
4) An adjustable body-strap system, wherein a single body-strap is held by a tunnel structure at inner side of the front bib. This body strap is able to encircle the wearer's body, allows the apparatus to be securely attached on the body and connects the ends of the strap to an adjustable buckle.
5) A hand-holder strap system, wherein a loop structure is attached on the distal end of an arm extension. It allows a caregiver's hand to hold on the wings securely without losing the grip during use. A caregiver would put a hand through the ring and would then carry the ring on the wrist, so as to use the full hand to hold onto the ends of the wings.
6) A tail-like locking strap system, wherein a tail-like structure is connected with the hand-holder that is affixed on the distal end of an arm extension. This strap system allows this apparatus to form a closed circle by a fastening assembly, which can be held by one hand, can function as a seat safety belt to secure a child onto a chair, or can be carried on the attendant should when the apparatus is not in use.

With these designs, this baby walking safety apparatus has a fashionable appearance, and is simple and versatile. The functions of this present invention include the following:
1) This invention allows a human holding a child of significantly different height without bending the back, so that there is minimal or no back pressure produced.
2) This invention prevents falls when an infant learns to walk.
3) This invention is a sport trainer safety device for training a small child to ice-skate/ski, bike, and many other out-door activities.
4) An added function is a safety restraining leash for toddlers.
5) An added function is a medical device or a physical therapy device for the child who has orthopedic problems.
6) An added function is a portable safety-belt that holds a baby onto a regular chair, a high-chair, car seat, stroller or shopping cart.

### BRIEF DESCRIPTION OF THE INVENTION

Before an infant is able to stand or walk on its own, the posture of an infant walking looks like an ox pulling a wagon. The babies' weights are mostly on their bodies. They tend to use their upper bodies to pull the legs because their legs are not strong enough to support their bodies in an upright position. Therefore, the small baby can fall out of the balance very easily. As we can see, infants normally keep a semi-vertical position while walking by slightly bending their upper bodies forward. To help an infant maintain his or her balance, the effective supporting area is at the upper front torso. Because adults and small babies have significantly different heights, the adult human's arms are not long enough to reach a baby's arms without bending the back or bending the knees. Naturally, every childcare attendant has to bend his or her upper body to grasp the baby's arm or hands when a small child is learning to stand or walk. As soon as a human bending the body forwardly, a pressure or strain is generated on the human's back. It is extremely painful to the people who have back injuries. It is painful and unpleasant for everyone because it is not a natural relaxing human physical posture. Thus, to help adults assist small children to stand/walk safely and comfortably, a novel device is made here that can meet all of these challenges. This present invention is a significant improvement over the prior arts.

This apparatus is a symmetrical structure, preferably made from any kind of fabrics or other material with soft, durable and flexible natures, such as leather or plastic as the exterior portion. The padding-materials are preferably polyesters, but should not exclude any other soft, durable and flexible materials. The soft flexible feature of these materials offers this apparatus for holding, carrying and lifting the baby from any direction or angle. This apparatus has multiple usages, such as holding a baby onto a chair, or any other seat structures. The wideness and padded feature makes this apparatus strong, secure and easy to be used for pulling, lifting, and swinging a child without causing any discomforts.

The major body part of this apparatus comprises a center portion named as the front bib. It translates from the front to just behind the armpits of the wearer, and functions as the supporting element for the upper torso. This center portion comprises a first surface and a second surface, with the first surface having an exterior surface and an interior surface. Similarly, the second surface has an exterior surface and an interior surface. The first surface interior surface is opposite to the second surface interior surface, with padding materials inserted between the opposite surfaces. The best description of its shape is an inverted top portion of a hand-fan with narrowing ends. The important features of this front bib are: i) a wide and big middle portion; ii) gradually curving up ends from the center, the top edge being less curved and the bottom edge being more curved, and also iii) gradually narrowing down ends from the center, terminating with narrower ends. Since the attendant is significantly taller than the wearer, the pulling force comes from up from a slight vertical position, which is neither horizontal nor vertical. The shape of the center portion allows the connection with the arm-extensions in a perfect position to meet this consideration. The features above are essential to allow a) the center portion fit naturally with the infant upper torso curve; and b) the pressure to be evenly diffused over a large area of the body without having any discomfort. The prior art baby walking safety harnesses use webbing straps. Even though some products used the padded feature, they are still too narrow to secure an infant when carrying or lifting an infant with 20-30 pounds of body weight. Plus, the body weight lands on the infant's front chest are not diffused in an efficient area and can cause extremely discomfort for a small child.

Two elements that extend the attendant's arms are designed as a pair of wings. They are referred to as arm-extensions. The arm-extensions attach to a center portion in a symmetrical position at both ends, giving this major body part of baby walking safety belt apparatus a semicircular shape. Similar to the center portion, each arm-extension comprises a first surface (outer side) and a second surface (inner side) where each surface has an exterior surface and an interior surface. A padding material is inserted between these interior portions. The shape of the arm-extension looks like a dragon-fly's wing. The fixed end has the same width as the front bib's ends. The anterior edge is preferably straight, and the posterior is curved, gradually widening up from the fixed end to the distal end, forming a wing shape like a dragon-fly's. When it is pulled, the arm-extensions naturally slide up-right toward the attendant's front body from the wearer's back, like two human arms. They are wide and well-padded, providing good protection and a strong lift to the wearer, controlling the balance of the child when s/he is in any motion. In contrast, the prior art baby walking harnesses use webbing straps as a leash held by the attendant hands, providing no protection to the wearers. Thus, the body portion of the apparatus of the present invention assists infant to walk and extends the attendant's arms.

Two shoulder straps can be carried on the wearer's shoulder separately. They are used to secure the apparatus on the wearer's body. Each shoulder strap has two ends. The first end is preferably affixed on the center top of the front bib. The second end preferably passes through a D-ring which is affixed permanently on the arm extension second surface (inner side) exterior surface adjacent to the center portion. The left and right straps are attached with a latching portion of a quick released center buckle on the second ends. When it is in use, two straps are connected with each other from opposite direction and form a closed circle that translates from front to the back of the shoulder. Each latching part of the center buckle is designed to slide on the strap it is attached to, so that each shoulder strap is adjustable.

A body-strap is a single long strap with a first end and a second end that encircles a wearer's body by a fastening assembly. It is used to secure the apparatus on the wearer's body. The first end is separated from the second end by passing through a tunnel structure, which is designed as a body-strap holder patching on the inner side of the front bib. This tunnel structure has an exterior surface and interior surface. The interior surface is opposite to the exterior surface of the second surface of the front bib. It is a long narrowed rectangular shape with a width that a body strap can pass through without any difficulty. The length is always shorter than that of the front bib. This way, it can secure better to a smaller child. The ends of the body strap float out from each left or right opening and each connects to a center buckle latching portion. When the body strap is in use, the center buckle is latched on the wearer's back so that the center front portion is securely attached on the wearer's body like a garment. The body strap can also secure a baby on a chair or a seat structure serves as a safety belt. By using a center buckle, the body strap is adjustable at both ends.

A hand grasp area is provided at the distal end of the arm-extension that allows the attendant's hands to hold onto the apparatus. A loop structure designed as a hand-holder provides a means of securing the attendant's hand without loosening grip on the apparatus. When the apparatus is in use, the attendant's hands passes through the loop and allow the loop to rest on the attendant's wrist, so that the attendant can grasp the arm-extensions fully.

An additional structure connecting the hand-holder's loop structure is a tail-like locking strap. These two elements are generated from a single strap by simply folding one end facing down toward the middle point and leaving the other end free like a tail. The middle point is attached on the outer side of the arm extension. Either element can be positioned on the distal end of the arm-extension. These two elements extend to opposite directions along the center line that parallel the arm-extension. Each tail-like locking strap is attached with a fastening portion of a center buckle. With a fastening assembly, the locking-straps from each arm-extension provide a means of connecting the distal ends of the arm-extensions. It allows the arm-extension to form a closed circle, when this apparatus secures a baby on a chair, is held by a hand or rests on the attendant's shoulder.

When this apparatus is in use, both the shoulder straps and the body strap are latched together on the wearer's back. These two strap systems provide a double securing system that protects the wearer's back when the arm-extensions are pulled from the wearer's front. With using these two strap securing systems, this apparatus is a garment-like structure that securely surrounds the wearer's upper torso. In addition, holding the shoulder strap by the D-rings, the shoulder strap is not loose from the wearer's shoulder. Thus, this garment structure is able to withstand the force from any direction without becoming loose. While carrying, lifting, swing, or pulling the wearer, this apparatus provides a strong support and a secure area between the wearer and the attendant. The apparatus can function as a lifting carrier for easily moving a baby from one spot to the other spot.

When it is not in use, the apparatus can be kept on the wearer's back when babies are crawling, standing, walking or sitting. Its appearance looks like a decorative costume for a small child. The floating ends of the arm-extensions can be lifted up and folded over and crossed on the wearer's back; they are secured by the connecting shoulder straps. These two arm-extensions look like a pair of butterfly wings or a pair of angle wings freely floating on the back.

The advantages of this present invention over all other prior art are as following:
1. An apparatus of the present invention is a simple design, which is easy to make and easy to use.
2. It is a well-padded fabric product that provides soft and strong support to the wearers. The wide, soft, and naturally adjustable fabric meets these multiple functions and purposes perfectly.
3. The wide body part provides a strong support and protection, that allows the apparatus to be used by younger infants and eases the burden during the most difficult time of parenting:
   i) The center portion covers a large area of the wearer's body and provides good protection surrounding the upper torso.
   ii) The two arm-extensions are able to direct the wearer's movement from any direction, providing support to the wearer, and functioning as the extended human arms for the caregiver.
4. This apparatus can remain on the wearer when the wearer is sitting, crawling or being carried by adults.
5. Adjustable straps fit different sized babies, giving a long useful life and providing additional functions.
6. It is fashionable, looks like a costume with a pair of angled wings.
7. It is versatile and can be used for multiple purposes, such as:
   i) Physical therapy;
   ii) As a Sport trainer safety belt;
   iii) As a portable chair safety belt;
   iv) As a leash of a walking harness;
   v) As a baby swing, providing good exercise for both babies and parents.

### LIST OF RELATED ART

U.S. Pat. No. 1,190,374, August 1916, V. B. Gilliam

U.S. Pat. No. 1,749,999, Mar. 11, 1930, Edna L. Croker,

U.S. Pat. No. 2,956,616, Oct. 18, 1960, J. R. Labusky et. al

U.S. Pat. No. 3,237,939, Mar. 1, 1966, William M. Oliver

U.S. Pat. No. 3,778,052, Dec. 11, 1973, Paul Andow,

U.S. Pat. No. 4,922,860, May 8, 1990, Deborah A. Hutchings,

U.S. Pat. No. 4,981,110, Jan. 1, 1991, Giannina Llewellyn,

U.S. Pat. No. 5,120,287, Jun. 9, 1992, Linda E. Brown,

U.S. Pat. No. 5,388,551, Feb. 14, 1995, Jack Martusceillo,

U.S. Pat. No. 4,666,017, May 19, 1987, Donald, A. Zimmerman

U.S. Pat. No. 5,766,114, Jun. 16, 1998, Douglas 0. Campbell,

U.S. Pat. No. 6,196,949, Feb. 2, 1999, Rubeb Rodarte,

U.S. Pat. No. 6,836,902, April 2005, Alejandra G. Marquez

### BRIEF DESCRIPTION OF THE DRAWINGS

FIG. 1 is the side front elevation view of the baby walker/walking safety belt apparatus constructed in accordance with the present invention.

FIG. 2 is a rear elevation view of the baby walker/walking safety belt apparatus constructed in accordance with the present invention.

FIG. 3 is a bird's eye view of the outer side of the baby walker/walking safety apparatus with a symmetric structure constructed in accordance with the present invention.

FIG. 4 is a bird's eye view of the inner side of the baby walker/walking safety belt apparatus with a symmetric structure constructed in accordance with the present invention.

FIG. 5 is a detailed drawing of the inner side of the center portion of the present invention to showing its construction, in accordance with the present invention.

FIG. 6 is a bird's eye view of the outer side of the arm-extension of the baby walker/walking safety belt apparatus constructed in accordance with the present invention; the hand-holder and the locking straps are constructed in two different ways.

FIG. 7A is a side elevation view of the baby walker/walking safety apparatus constructed in accordance with the present invention, showing how it is attached to a small child; FIG. 7B is a rear elevation view of the baby walker/walking safety belt apparatus constructed in accordance with the present invention, showing how the straps securely lock on the small baby's back.

FIG. 8 is a side elevation view of the baby walker/walking safety belt apparatus constructed in accordance with the present invention; showing its use by an attendant helping a small baby learning how to walk.

FIG. 9 is a rear elevation view of the baby walker/walking safety belt apparatus constructed in accordance with the present invention, showing the apparatus resting on the wearer's back as: A. butterfly wings; B. angle wings free flowing on the wearer's back.

FIG. 10 is a rear view of the baby walker/walking safety belt apparatus constructed in accordance with the present invention, showing holding a baby onto a chair by both body strap system and the chair holder system; these straps are locked together by the center buckles.

FIG. 11 depicts a front view and a rear view of an alternative manner of installation and use of the shoulder straps.

### DETAILED DESCRIPTION OF THE INVENTION

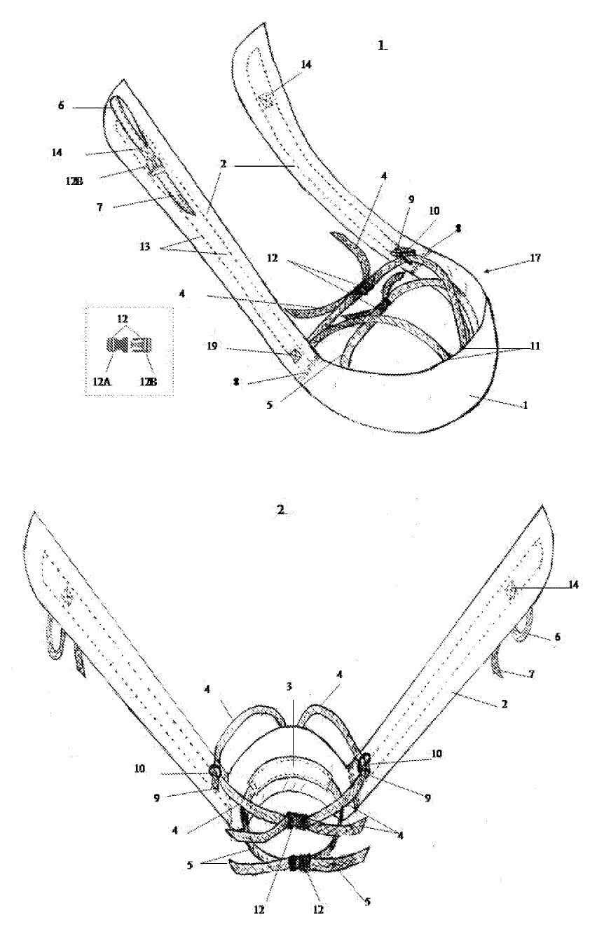

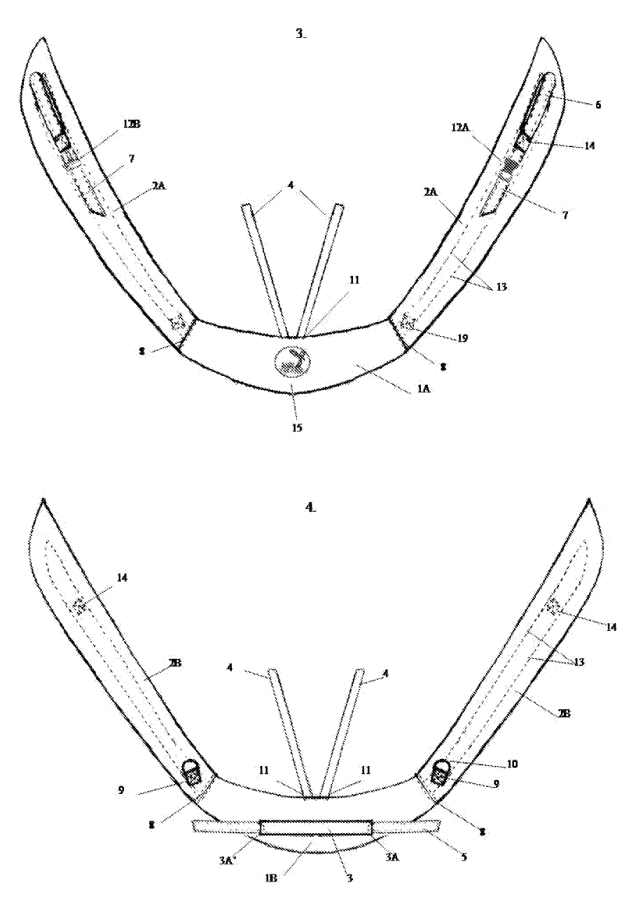

This invention provides a portable device for use by one holding an infant in any motion without back bending. It is used to train an infant walk. Referring now to the drawings, wherein similar parts of the invention are identified by like reference numerals. The baby walker/walking safety belt apparatus (17) as seen from the front side view in FIG. 1 having a main body part including a padded center portion (1) referred to as the front bib and two identical wing-shaped structures (2) referred to as the arm-extensions, which are joined (8) on both side. It comprises two securing strap systems that allow the apparatus to attach on the wearer's body, they are the shoulder-strap system (4, 9, 10, 11, 12), and the body-strap system (3, 5, 12). It also comprises a hand-holder strap system (6, 14) and a tail-like locking-strap system (7, 14, 12). Overall, this walking safety apparatus is constructed in a symmetrical semi-circular shape, as seen in FIGS. 2, 3 and 4.

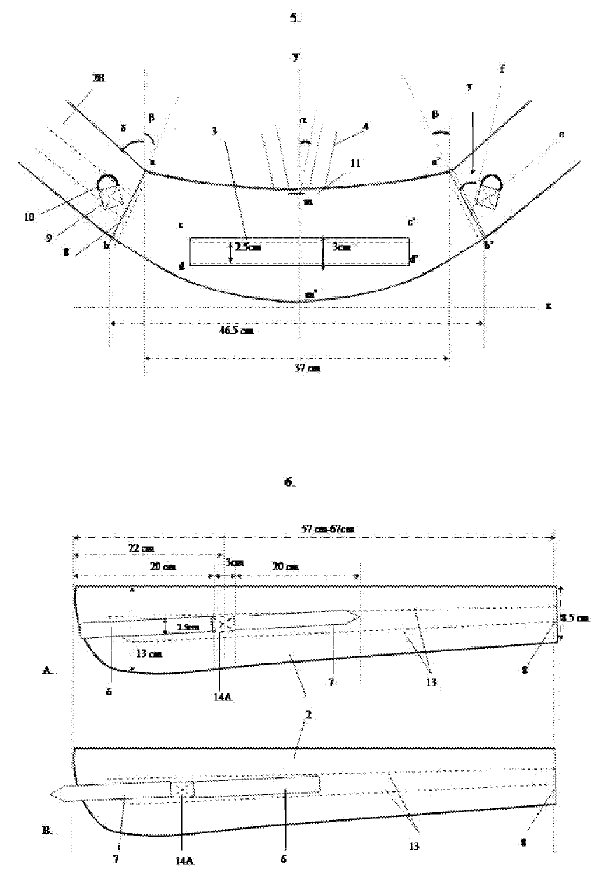

1. An apparatus of the present invention may be constructed mainly by six pieces of fabric, three pieces for the first surface of the apparatus, see FIG. 3; and three pieces for the second surface of the apparatus, see FIG. 4. The straps are preferably constructed by the same fabric as the exterior cover, and are padded with proper materials that can make the strap supportive and strong. The width of these straps is preferably 2.5 cm wide. The length of each strap varies from part to part as required.

2. The front bib has two surfaces, the first surface (1A) and the second surface (1B), as shown in FIGS. 3 and 4. The exterior surface of the first surface (1A) contains a stitched logo (15) at the center front, FIG. 3. FIG. 5 represents the basic parameters necessary for the construction of the apparatus, on the exterior side of second surface (1B). The hairy dash lines are employed here to illustrate the angles and measurements. The line x, is the horizontal line indicating the bottom edge position. The line y is the vertical line extended by the middle line of mm′. The center portion (1) has a length of 12 cm from top edge (aa′) to the bottom edge (bb′), and each end (a-b or a′-b′) is 8.5 cm long. The distances between the two top edges represented by a-a′ is 37 cm long; and similarly, the bottom b-b′ is 46.5 cm long. The end of the front bib (a-b or a′-b′) forms a 30-degree angle with the vertical line (a) or (a′). From the center, these two ends curve up smoothly toward the armpit areas, and then narrow down and terminate at the point (8) just behind the armpits. The bottom edge bb′ forms a big arched shape with a big curve and the top edge aa′ has a smaller curve. The distance from the edge b or b′ to the line x is about 7 cm long. At a-b and a′-b′, this center portion is connected with the arm-extensions (2) in a vertical position. Line e represents the center line of the arm extension and is vertical to the line a-b. The other arm-extension is substantially the same.

3. A body-strap holder (3) is on the exterior side of the second surface (1B) of the front bib. It is rectangular, being 28 cm long and 3 cm wide (see FIG. 5). By sewing the edges from c′ to c, and d′ to d, it forms a tunnel structure with two open ends (3A, 3A′). This structure can be constructed prior to connecting 1A and 1B together.

4. The two shoulder straps (4) are in a symmetrical position attached at (11) on the top of the center portion (1). Each shoulder strap is 40 cm long, having a fixed end and a free end. The second step of constructing the apparatus is to attached 1A and 1B together at its top edge aa′ by sewing from the internal surface of each surface. During this process, each end of the body strap is inserted and affixed at position (11), see FIG. 5. The shoulder straps are about 4 cm apart. Each shoulder strap is 2 cm apart from the center line y and slides away from the center at a 20-degree angle, see FIG. 5.

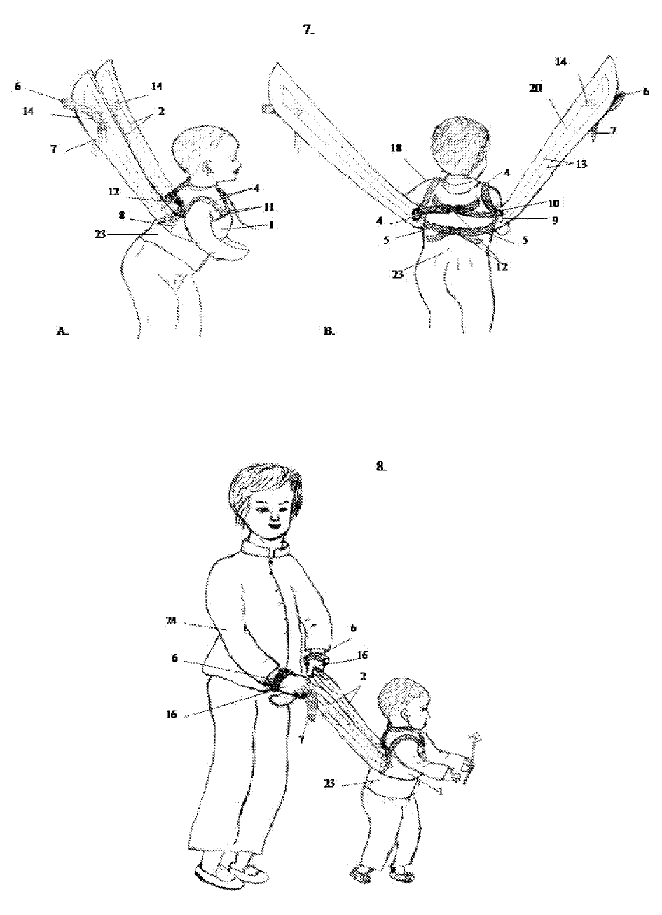

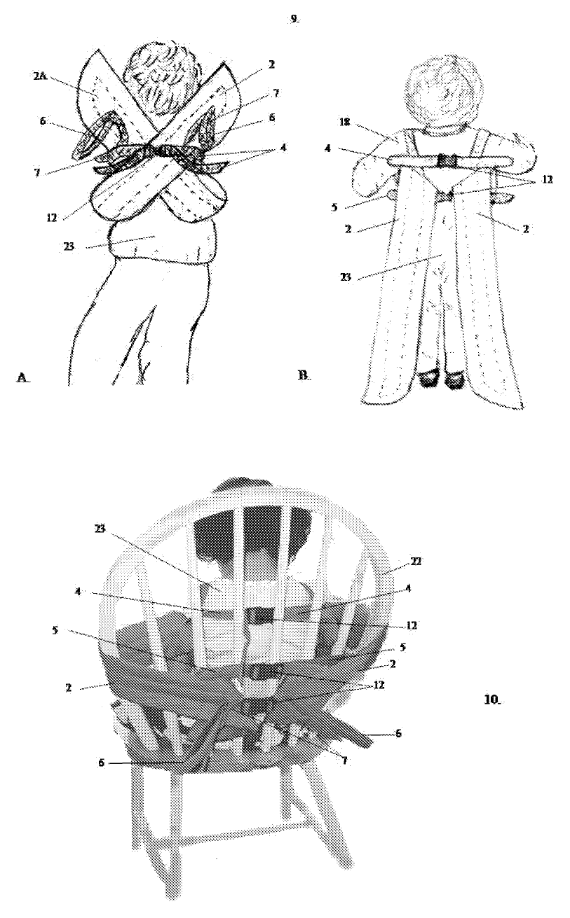

5. The arm-extensions (2) each preferably have a first surface (2A) and a second surface (2B). But, in most cases, these two surfaces are cut into a single piece of fabric and fold on the center, as shown in FIG. 6. The opening edges are sewn together from internal side of the surfaces. After depositing the padding material, the padded arm extension (2) is connected to the padded center portion (1) at (8) by sewing with at least two lines.

The shape of the arm-extension is designed as a dragonfly's wing, as shown in FIG. 6. The fixed end is 8.5 cm wide and is connected with the front bib (1) at point (8). This wing structure is gradually widening and curves up at the distal end. The widest part near the end is 13 cm wide. The length of the wing is about 57 cm. As described above, the angle between the extension arm (line e) to the front bib end (a-b) is about 90 degrees, and to the vertical line (line a or line a′) is near 60 degrees, see FIG. 5. Due to this angle of the connection, the arm-extension extends upward naturally behind of the wearer's back, and to be held by the attendant's hands without back bending. The length of the arm extension is not limited to 57 cm long. The purpose of this shape at the distal end is for the fashion dictates. It looks like a pair of angle wings floating on the wearer's back, as shown in FIG. 9. Both the shape and the length of this arm extension can be modified without losing its spirit and function. Two additional parallel stitched (13) lines on the arm-extensions are necessary to make these wings much stronger. With padding, these wings are durable and strong enough for stretching and heavy lifting.

6. Two D-ring (or triangle ring) structures (10) are then attached on the inner side (2A) of each arm-extension at (19) in a symmetrical position. Each D-ring (10) is affixed by a holder (9) made by a short strap, see FIG. 5. The ring holder (9) is about 3 cm long, 2.5 cm wide, attaching a D-ring prior to sew it on the arm-extensions. The angle is about 45 degrees between the holder (9) (presented by line f) and the front bib (a′-b′). It is at the center position of the arm-extension, and is 2 cm apart from the closest edge of the holder (9) to the center portion (a′-b′). This 45-degree angle allows the shoulder straps a) to connect with each other in a natural position on the wearer's back; b) to connect the front bib and the arm-extensions into a closed circle when both straps are latched together; c) to allow the arm extensions resting on the wearer's back form a nice V-shape, see FIG. 9B. Each distal end of the shoulder strap attaches to a latch portion of a center buckle (12) immediately after passing through this D-ring. When the apparatus is in use, the two ends are latched together on the wearer's upper back. With the additional latched body strap, this apparatus becomes a garment structure that completely secures the wearer's upper body and protects the wearer when in lifting, pulling, and swinging.

7. The body-strap (5) is a free single strap that is 80 cm long. The first end passes through the tunnel structure (3), and come out of the other end of tunnel. Thus, these two ends are separated from each other at 3A and 3A′. Each end is immediately attached to a latching portion of a center buckle (12A, 12B). Since the structure (3) that provides a means of securing and strengthening the body strap is not physically attached to the apparatus, it is removable and replaceable. The advantages of this design are: a) it makes the apparatus strong and secure; b) it allows this apparatus to fit all sizes of babies; and c) it gives multiple functions to the apparatus.

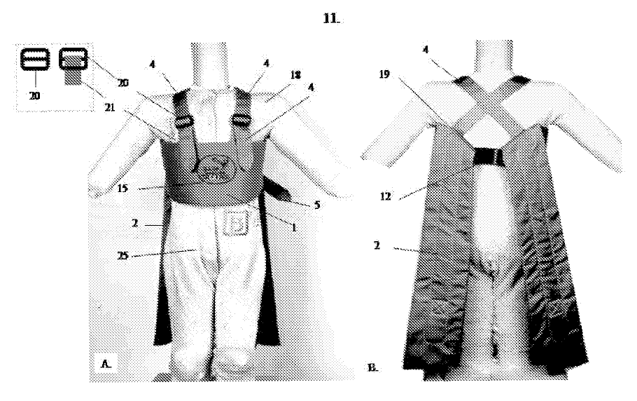

8. Each extension-arm is constructed with a hand-holder (6) and a locking strap (7) near the distal end, see FIG. 6. These two structures (6, 7) are constructed from a single long strap (66 cm), folding the first end of the strap toward the middle section to make a loop (7) of 23 cm long, then leaving the rest part free like a tail (7) about 20 cm long, and then, affixing the middle part with the first end facing down to the first surface (2A) of the arm extension. A stitched area (14) is made about 3 cm×2.5 cm size centered on the arm-extension. The length of both structures is about 20 cm long. They extend to the opposite directions and parallel with the arm extensions, see FIG. 6. Each tail strap is connected with a latch portion of a center buckle (12) which is facing toward distal end of the wing, FIG. 3. The hand-holder (6) and the locking strap (7) can be made in two different manners, see FIGS. 6A, 6B. The structure made by the drawing in FIG. 6A allows the apparatus to buckle on the chairs with a thinner back. The construction made in the drawing in FIG. 6B allows a few inches long for the arm-extension. There is no difference on the function of holding a child to walk. When the locking strap forms a closed circle, it can hold a child on a chair (23) by latching the buckle together, see FIG. 10. The loop structure (6) allows the attendant's (24) hands (16) to pass through and rest on the wrists, it prevents the hands (16) from losing the wings, see FIG. 7.

9. In addition, extra padding can be provided in the armpit area to provide extra comfort when a strong lift occurs.

10. The present apparatus is preferably made of fabric. Since the fabric is soft and flexible, it does not need to be taken off while baby is in crawling, sitting, and eating positions. To avoid the arm-extensions (2) from touching the floor, they can be simply lifted by crossing over each other and folded back on the wearer's back. When held by the latched shoulder-straps (4, 12), these two arm-extensions form a pair of butterfly-like wings behind the wearer's shoulder, see FIG. 9A. Also, the two arm extensions can float freely on the wearer's back. Fabrics fit this purpose perfectly. During hot or warm weather, the wearers do not need to wear any clothes, so the cotton fabric for this apparatus is ideal. The little wearer will look like an angel with wings or with butterfly wings, FIG. 9. This present invention has considered both usefulness and fashion. In contrast, the harnesses of the prior art made by webbing straps are too harsh for a baby to wear during the summer time. With careful design, this invention satisfies both needs that the prior art did not consider.

11. In FIG. 11, pictures A and B present alternative constructions of a shoulder strap system. A strap slider (21) fastens the free end of each shoulder strap. A strap-held slider (20) is attached at the top center of the front bib at the position (11). While sewing the two front bib surfaces 1A and 1B together from a to a′, two of these structure (20) are inserted between the surfaces in a symmetrical position, each apart from the center line y of 2-4 cm. The slider holder is the loop about 3-4 cm long, holding the center bar of the slider (21). The fixed end of each shoulder strap is attached at (19) wherein the same way a D-ring (10) holder (9) is attached. When these straps are in use, the free ends make a crisscross over on the wearer's back, see FIG. 11B, and then extend around the shoulders (18) and connect with the sliders (20) in the center front, FIG. 11A. This manner of installation of the shoulder straps is as equally securing as the system described in section 4 and 6, above.

1. A baby walker/walking safety belt apparatus attachable to an infant or a wearer and operated by an attendant who is a significantly taller than the wearer, allowing an attendant to train, assist, or hold the wearer in a normal physical position, this apparatus comprises:
a) A semi-circular belt shaped main body part with i) a center section connected by ii) two extended elements in a symmetrical position, the center element supporting the wearer's upper front chest area, the free ends of the extended elements provided for grasping by the attendant hands; and
b) Securing strap systems including i) two shoulder straps secured on the top of the front center section, the distal ends passing a D-ring attached on the extended elements and connected to each other by a fastening assembly; ii) a body strap system secured by a tunnel-like structure encircling the wearer's body by a fastening assembly; iii) a pair of loop-shaped hand-holders attached on the hand grasping area of the extended elements; and iv) a pair of locking straps connected to the loop-shaped hand-holders by a fastening assembly.

2. The apparatus of claim 1 wherein the center section being padded to support a baby's upper front body.

3. The apparatus of claim 1 wherein the two wing-shaped elements are soft padded belts.

4. The apparatus of claim 1, wherein the extended elements are wing-shaped.

5. The apparatus of claim 1 wherein the center portion and the two extended elements are made as a single or multiple pieces.

6. The apparatus of the claim 1 wherein one of the securing strap systems allows the apparatus to be attached on the wearer's body.

7. The apparatus of claim 1 wherein the shoulder strap system is affixed to one of two positions, the first position being on the top edge of the center element and the second position being on the inner side of one of the wing-shaped elements.

8. The apparatus of claim 1, the shoulder straps each having a first end and a second end, wherein the first end is secured on the first position of claim 7, and the second end passes through a D-ring that is attached on the second position of claim 7.

9. The apparatus of claim 7, wherein the free ends of the shoulder straps are connected with a fastening assembly.

10. The apparatus of claim 7, wherein the shoulder straps extend across the back of the wearer in a crisscrossing fashion and coming to the front chest area, attaching to a fastening assemble affixed on the top edge of the center section.

11. The apparatus of the claim 1, wherein the body strap system encircles the wearer's body by at least one body strap passing through a tunnel that is patched on the exterior surface of the second surface of the center portion.

12. The apparatus of claim 1, wherein the body strap is a single strap having the first end and the second end.

13. The apparatus of claim 12, wherein the ends of the body strap connect to a fastening assembly.

14. The apparatus of the claim 1 wherein the loop structure includes a hand-holder attached near the distal end of the extended element to be used to secure a hand.

15. The apparatus of claim 1 wherein a strap is attached near the distal end one of the extended elements, connecting a fastening assembly that allows the strap to be adjustable, and connecting the extended elements to form a closed circle.

16. The apparatus of claim 1, having at least one attaching strap system.
